(19) United States
(12) Patent Application Publication
(10) Pub. No.: US 2014/0109071 A1
(43) Pub. Date: Apr. 17, 2014

(54) METHOD FOR UPDATING OPERATING SYSTEM AND HANDHELD ELECTRONIC APPARATUS

(71) Applicant: ASKEY COMPUTER CORP., New Taipei City (TW)

(72) Inventor: Hsi Yun Ding, New Taipei City (TW)

(73) Assignee: ASKEY COMPUTER CORP., NEW TAIPEI CITY (TW)

(21) Appl. No.: 13/776,725

(22) Filed: Feb. 26, 2013

(30) Foreign Application Priority Data
Oct. 15, 2012 (TW) 101137943

(51) Int. Cl. G06F 9/445

(52) U.S. Cl. CPC G06F 8/65
USPC 717/168

(57) ABSTRACT

A method for updating an operating system (OS) and a handheld electronic apparatus are provided. In the method, when an updating instruction is received by the handheld electronic apparatus, an updating procedure is executed by an updating module of firmware in the handheld electronic apparatus. The updating procedure includes steps of backing up item data in a first storage area to a second storage area, updating the OS that is installed on the first storage area, and restoring the item data from the second storage area to the first storage area after the OS is completely updated.

### CROSS-REFERENCE TO RELATED APPLICATION

This application claims the priority benefit of Taiwan application serial no. 101137943, filed on Oct. 15, 2012. The entirety of the above-mentioned patent application is hereby incorporated by reference herein and made a part of this specification.

### BACKGROUND OF THE INVENTION

1. Field of the Invention

The invention relates to a data updating mechanism. More particularly, the invention relates to a method for updating an operating system (OS) and a handheld electronic apparatus.

2. Description of Related Art

As the so-called information explosion era dawns, electronic products have become indispensable in our daily lives. With the continuous progress of the electronic technology, electronic products with humanization designs and functionality have been continuously developed. As for the development and application of personal computers, desktop personal computers (desktop PCs) are firstly developed, whereas the desktop PCs have the defects of bulkiness and poor portability. Hence, the easy-to-carry notebook computers and tablet PCs have been further developed. The existing tablet PCs, however, have following disadvantages. Once an operating system (OS) is upgraded, the existing data or the downloaded application programs are deleted or overwritten during the updating process, thus leading to critical data loss or necessity of re-downloading the application programs.

### SUMMARY OF THE INVENTION

The invention is directed to a method for updating an operating system (OS) and a handheld electronic apparatus. By conducting the method or applying the handheld electronic apparatus, the OS may be updated and the existing data may be backed up even when the OS is in a recovery mode.

In an embodiment of the invention, a method for updating an OS suitable for a handheld electronic apparatus is provided. In the method, the handheld electronic apparatus receives an updating instruction, and an updating procedure is then executed by an updating module of firmware in the handheld electronic apparatus. The updating procedure includes steps of backing up item data in a first storage area to a second storage area, updating the OS that is installed on the first storage area, and restoring the item data from the second storage area to the first storage area after the OS is completely updated.

According to an embodiment of the invention, the step of executing the updating procedure further includes: displaying a menu that lists a plurality of options, selecting at least one of the options according to a selection instruction, and setting existing data corresponding to the at least one selected option as the item data.

According to an embodiment of the invention, the item data may include a contact list, a message, an electronic mail, an application program, an audio file, a video file, or a picture.

According to an embodiment of the invention, the method further includes rebooting the handheld electronic apparatus after completely executing the updating procedure.

According to an embodiment of the invention, the first storage area and the second storage area are located in one storage unit that is built in the handheld electronic apparatus. Alternatively, the first storage area is a storage unit that is built in the handheld electronic apparatus, and the second storage area is another storage unit that is externally connected to the handheld electronic apparatus. Here, the storage unit externally connected to the handheld electronic apparatus is a secure digital (SD) card, for instance.

In an embodiment of the invention, a handheld electronic apparatus that includes a first storage area, a second storage area, a firmware unit, and a processing unit is provided. The processing unit is coupled to the first storage area, the second storage area, and the firmware unit. An operating system (OS) is installed on the first storage area. The firmware unit includes firmware; the firmware includes an updating module; the updating module has an updating procedure. When the processing unit receives an updating instruction, the processing unit controls the firmware to execute the updating procedure through the updating module, so as to back up item data in the first storage area to the second storage area, updates the OS, and restores the item data from the second storage area to the first storage area after the OS is completely updated.

In view of the above, the update of the OS and the backup of the existing data may be completed at the same time, and the backup of the existing data is restored to the original location of the data after the update of the OS is completed. Thereby, the complicated procedure of manually backing up and restoring the existing data may no longer be necessary.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram illustrating a handheld electronic device according to an embodiment of the invention.

FIG. 2 is a flowchart illustrating a method for updating an operating system (OS) according to an embodiment of the invention.

FIG. 3 is a flowchart illustrating a method for updating an OS according to another embodiment of the invention.

FIG. 4 is a schematic view illustrating a menu according to an embodiment of the invention.

### DESCRIPTION OF EMBODIMENTS

Generally, after an operating system (OS) is updated, the existing data in the apparatus are likely to be removed or overwritten, thus resulting in critical data loss, necessity of re-downloading application programs, or other problems. Accordingly, the invention is directed to a method for updating an OS and a handheld electronic apparatus that may automatically back up the existing data and restore the existing data after the OS is completely updated. In order to make the invention more comprehensible, embodiments are described below as the examples to prove that the invention can actually be realized.

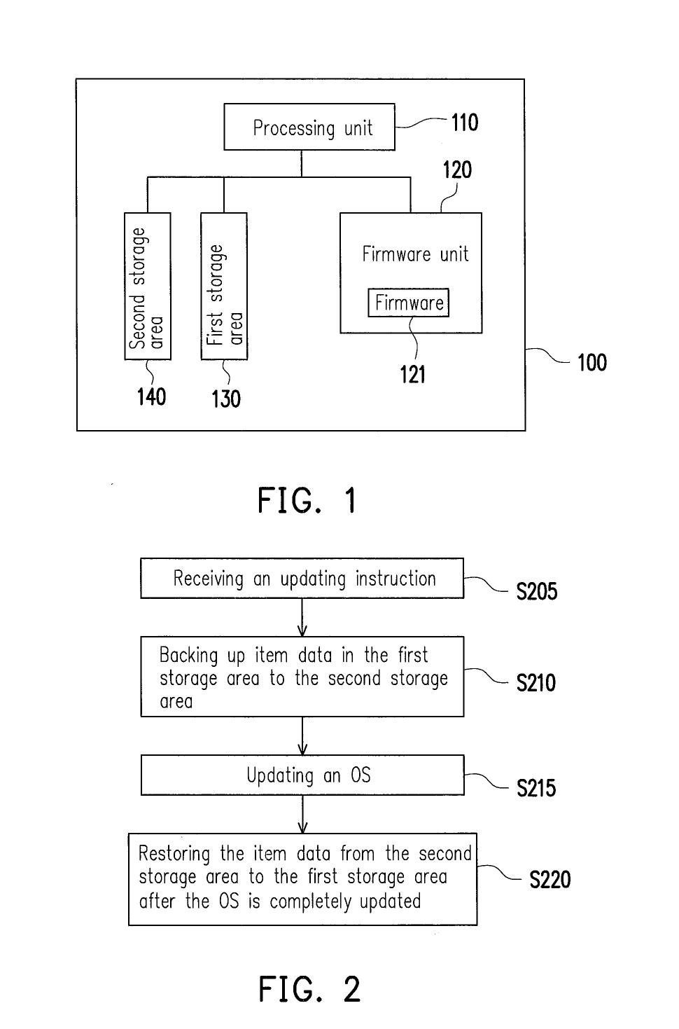

FIG. 1 is a block diagram illustrating a handheld electronic device according to an embodiment of the invention. With reference to FIG. 1, the handheld electronic apparatus 100 mainly includes a processing unit 110, a firmware unit 120, a first storage area 130, and a second storage area 140. The processing unit 110 is coupled to the firmware unit 120, the first storage area 130, and the second storage area 140. Here, the handheld electronic apparatus 100 is, for instance, a mobile phone, a smart phone, a tablet PC, a navigation apparatus, and so forth.

The firmware unit 120 includes firmware 121. Here, the firmware unit 120 is, for instance, a read only memory (ROM) or a flash memory; the firmware 121 is, for instance, a basic input or output system (BIOS), an extensible firmware interface (EFI) BIOS, or a unified extensible firmware interface (UEFI) BIOS. The firmware 121 includes an updating module, and the updating module has an updating procedure.

An OS is installed on the first storage area 130, and the second storage area 140 serves to back up data. In the present embodiment, the first storage area 130 is a storage unit that is built in the handheld electronic apparatus 100, and the second storage area 140 is another storage unit (e.g., a secure digital (SD) card) that is externally connected to the handheld electronic apparatus 100, for instance. The handheld electronic apparatus 100 may be further equipped with a card slot that may be externally connected to the SD card.

In another embodiment of the invention, the first storage area 130 and the second storage area 140 may be both located in one storage unit that is built in the handheld electronic apparatus 100. For instance, the usable area of the built-in storage unit may be divided into the first storage area 130 and the second storage area 140. Nevertheless, the invention should not be construed as limited to the embodiment set forth herein.

The processing unit 110 is, for instance, a central processing unit (CPU), a microprocessor, a micro control unit (MCU), and so on, and the processing unit 110 may serve to execute hardware and firmware in the handheld electronic apparatus 100 as well as process data in software.

When the processing unit 110 receives an updating instruction, the processing unit 110 controls the firmware 121 to execute the updating procedure through an updating module. For instance, during the updating procedure, the firmware 121 backs up item data in the first storage area 130 to the second storage area 140 through the updating module, updates the OS, and restores the item data from the second storage area 140 to the first storage area 130 through the updating module after the OS is completely updated. The item data may include a contact list, a message (e.g., a short message service (SMS)), an electronic mail, an application program, an audio file (e.g., music), a video file (e.g., a video clip), a picture, etc.

Steps in a method for updating the OS are described below with reference to the aforementioned handheld electronic apparatus 100.

FIG. 2 is a flowchart illustrating a method for updating an operating system (OS) according to an embodiment of the invention. With reference to FIG. 1 and FIG. 2, in step S205, the processing unit 110 receives the updating instruction. The handheld electronic apparatus may be equipped with an input unit, e.g., a keyboard or a touch panel, and a user enables an updating function through the input unit to transmit the updating instruction to the processing unit 110. When the processing unit 110 receives the updating instruction, the processing unit 110 controls the firmware 121 to execute the updating procedure through the updating module. For instance, the updating module may enter a recovery mode to execute the updating procedure described below. Specifically, the updating procedure includes steps S210 to S220.

In step S210, the item data in the first storage area 130 are backed up to the second storage area 140 through the updating module in the firmware 121. Since the OS is installed on the first storage area 130, the existing data stored in the first storage area 140 are removed or overwritten after the OS is completely updated. Hence, prior to the update of the OS, the updating module in the firmware 121 is employed to back up the data.

In step S215, the OS is updated by the updating module in the firmware 121. For instance, the existing OS is upgraded to the latest version.

In step S220, after the update of the OS is completed, the item data are restored from the second storage area 140 to the first storage area 130 through the updating module in the firmware 121. That is, the backed up item data are restored; thereby, after the OS is completely updated, the data stored in the updated OS may be the same as the data stored in the old OS.

A menu may be configured for a user to select the data to be backed up. Another embodiment is provided below for explanatory purposes.

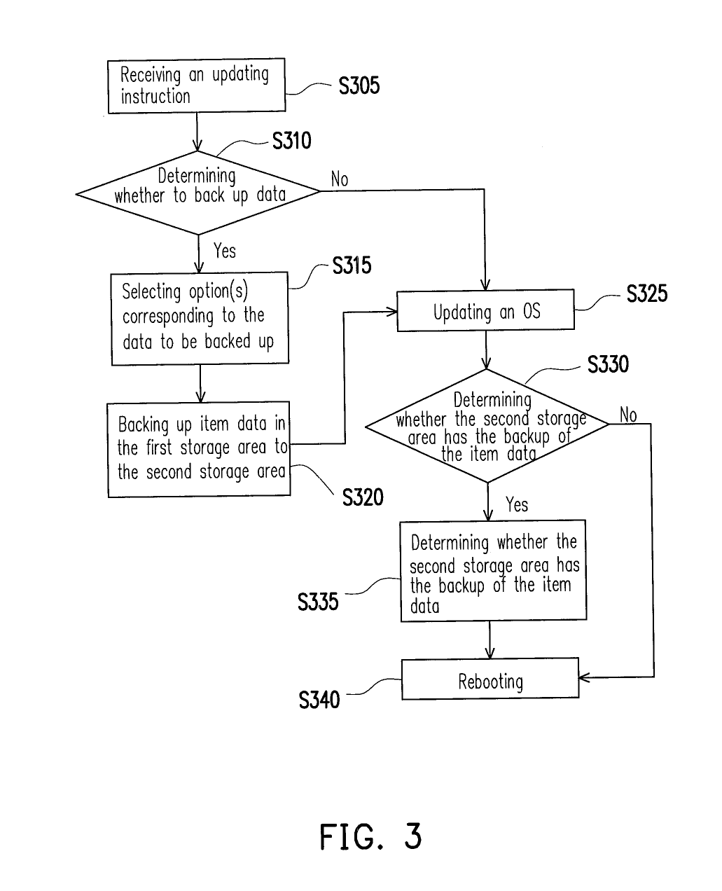

FIG. 3 is a flowchart illustrating a method for updating an OS according to another embodiment of the invention. With reference to FIG. 1 and FIG. 3, in step S305, the processing unit 110 receives the updating instruction and executes the updating procedure through the updating module in the firmware 121. Specifically, the updating procedure includes steps S315 to S335.

Prior to the updating procedure, in step S310, the updating module in the firmware 121 further determines whether the backup of data is necessary. A flag may be configured for said determination, for instance. When the flag is 0, the data are directly backed up; when the flag is 1, the data are not backed up. A user may set the flag in advance; alternatively, the processing unit 110 may, after receiving the updating instruction, issue an inquiry instruction (e.g., by displaying the instruction on the display screen) to inquire whether the user intends to back up the data. Said descriptions merely serve as an embodiment of the invention and should not be construed as a limitation to the invention.

If it is determined not to back up the data, in step S315, the updating module in the firmware 121 updates the OS. By contrast, if it is determined to back up the data, in step S315, the updating module in the firmware 121 selects the data to be backed up. For instance, all of the data may be directly selected, the preset data may be selected, or a menu may be provided to the user for real time selection.

For instance, the updating module in the firmware 121 provides a menu that is displayed on the screen and lists a plurality of options. Each of the options corresponds to one of the existing data. The updating module then selects one, some, or all of the options according to a selection instruction and sets the existing data corresponding to the selected option(s) as the item data.

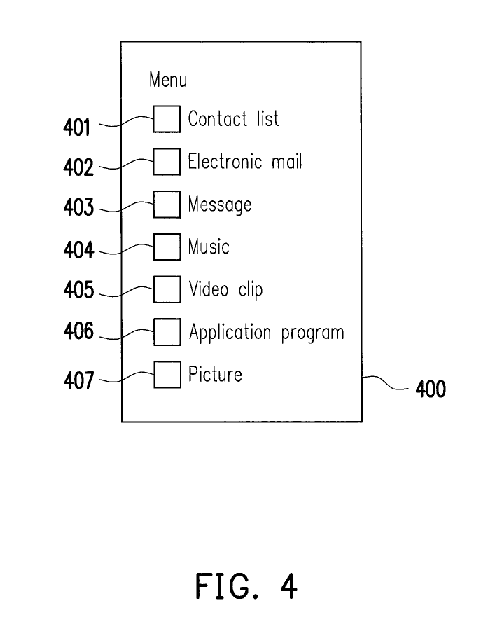

FIG. 4 is a schematic view illustrating a menu according to an embodiment of the invention. With reference to FIG. 4, the menu 400 includes options 401 to 407. The existing data corresponding to the option 401 may refer to a contact list; the existing data corresponding to the option 402 may refer to an electronic mail; the existing data corresponding to the option 403 may refer to a message; the existing data corresponding to the option 404 may refer to music; the existing data corresponding to the option 405 may refer to a video clip; the existing data corresponding to the option 406 may refer to an application program; the existing data corresponding to the option 407 may refer to a picture. Thereby, the user may issue the selection instruction through the menu 400. For instance, the selected option may correspondingly generate the selection instruction.

After the options corresponding to the data to be backed up are selected, in step S320, the updating module in the firmware 121 backs up the item data in the first storage area 130 to the second storage area 140. In step S325, the OS is updated by the updating module in the firmware 121. In step S330, whether or not the backup of the item data already exists in the second storage area 140 is further determined. If yes, it indicates that the updating module already performs the steps S315 and S320, and then the updating module performs step S335 to restore the backup of the item data from the second storage area 140 to the first storage area 140. The updating module in step S340 then reboots the handheld electronic apparatus 100.

If no backup of the item data exists in the second storage area 140, it indicates that the updating module has not backed up any item data to the second storage area 140, and then the updating module directly performs the step S340 to reboot the handheld electronic apparatus 100.

After the item data are restored from the second storage area 140 to the first storage area 130, the updating module may further delete the item data in the second storage area.

Given that the user selects the options 401 and 407, the updating module in the firmware 121 backs up the existing data (i.e., the contact list and the picture) respectively corresponding to the options 401 and 407 to the second storage area 140. After the update of the OS is completed, the updating module in the firmware 121 restores the backup of the contact list and the picture from the second storage area 140 to the first storage area 130.

In other embodiments of the invention, the updating module may be implemented in form of another firmware or in form of an electronic chip that is constituted by a plurality of logic gates and coupled to the firmware unit 120. Thereby, after the processing unit 110 receives the updating instruction, the processing unit 110 controls the firmware 121 to execute the updating procedure through the updating module. The way to implement the updating module is not limited in the invention.

To sum up, as described in the previous embodiments, the update of the OS and the backup of the existing data may be simultaneously completed when the OS is in the recovery mode, and the backup of the existing data is restored to the original location of the data after the update of the OS is completed. Thereby, the complicated procedure of manually backing up and restoring the existing data may no longer be necessary. Moreover, through conducting said method, the update of the OS and the backup of the existing data may be simultaneously completed directly in the handheld electronic apparatus without applying other electronic apparatuses, which facilitates the use of the handheld electronic apparatus.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A method for updating an operating system suitable for a handheld electronic apparatus, the method comprising:
receiving an updating instruction to execute an updating procedure by an updating module of firmware, wherein the step of receiving the updating instruction to execute the updating procedure comprises:
backing up item data in a first storage area to a second storage area;
updating the operating system installed on the first storage area; and
restoring the item data from the second storage area to the first storage area after completely updating the operating system.

2. The method as recited in claim 1, wherein the step of receiving the updating instruction to execute the updating procedure further comprises:
displaying a menu listing a plurality of options; and
selecting at least one of the options according to a selection instruction and setting existing data corresponding to the at least one selected option as the item data.

3. The method as recited in claim 1, wherein the item data comprises a contact list, a message, an electronic mail, an application program, an audio file, a video file, a picture, or a combination thereof

4. The method as recited in claim 1, after completely executing the updating procedure, further comprising:
rebooting the handheld electronic apparatus.

5. The method as recited in claim 1, wherein the first storage area and the second storage area are located in a storage unit built in the handheld electronic apparatus, or the first storage area is a storage unit built in the handheld electronic apparatus and the second storage area is another storage unit externally connected to the handheld electronic apparatus.

6. The method as recited in claim 5, wherein the storage unit externally connected to the handheld electronic apparatus is a secure digital card.

7. A handheld electronic apparatus comprising:
a first storage area, an operating system being installed on the first storage area;
a second storage area;
a firmware unit comprising firmware, the firmware comprising an updating module, the updating module having an updating procedure; and
a processing unit coupled to the first storage area, the second storage area, and the firmware unit;
wherein when the processing unit receives an updating instruction, the processing unit controls the firmware to execute the updating procedure through the updating module, and the updating procedure comprises: backing up item data in the first storage area to the second storage area, updating the operating system, and restoring the item data from the second storage area to the first storage area after the operating system is completely updated.

8. The handheld electronic apparatus as recited in claim 7, wherein the processing unit controls the firmware to execute the updating procedure through the updating module, so as to display a menu listing a plurality of options and select at least one of the options according to a selection instruction, and existing data corresponding to the at least one selected option is set as the item data.

9. The handheld electronic apparatus as recited in claim 7, wherein the item data comprises a contact list, a message, an electronic mail, an application program, an audio file, a video file, a picture, or a combination thereof.

10. The handheld electronic apparatus as recited in claim 7, wherein the processing unit controls the firmware to reboot the handheld electronic apparatus through the updating module after completely executing the updating procedure.

11. The handheld electronic apparatus as recited in claim 7, wherein the first storage area and the second storage area belong to a storage unit, or the first storage area belongs to a storage unit built in the handheld electronic apparatus and the second storage area belongs to another storage unit externally connected to the handheld electronic apparatus.
